(19) United States
(12) Patent Application Publication
(10) Pub. No.: US 2015/0110462 A1
(43) Pub. Date: Apr. 23, 2015

(54) DYNAMIC MEDIA VIEWING

(71) Applicant: Sling Media, Inc., Foster City, CA (US)

(72) Inventors: Mark Kikuya Maisenbacher, Palo Alto, CA (US); David Eyler, San Francisco, CA (US)

(73) Assignee: Sling Media, Inc., Foster City, CA (US)

(21) Appl. No.: 14/058,938

(22) Filed: Oct. 21, 2013

(51) Int. Cl. G11B 27/19; H04N 5/775; G11B 27/34; H04N 5/93

(52) U.S. Cl. CPC G11B 27/19; H04N 5/93; H04N 5/775; G11B 27/34
USPC 386/230; 386/248; 386/244

(57) ABSTRACT

A device is configured to record a stream of media content. The device determines that a value in metadata of the recorded media content associated with an index in the media content matches or exceeds a predetermined value. The device receives a request to play back the recorded media content and plays back the recorded media content beginning at the index specified by the metadata.

### BACKGROUND

Digital video recorders (DVR's) and the like may be used to record presentations of media content, such as sporting events, political events, etc. However, even when the subject of an item of media content is of interest to a user, e.g., a football fan may generally be interested in a football game, some or all portions of the item of media content may not be of interest to the user. For example, a user may not be interested in seeing an entire football game between teams the user does not follow, or may not have time to watch an entire game. Unfortunately, mechanisms are lacking to allow a user to record and view only portions of items of media content of interest to the user, e.g., exciting portions of a football game or other sporting event.

### DRAWINGS

FIG. 1 is a block diagram of an exemplary media content delivery system.

FIG. 2 is a block diagram of an exemplary interest graph.

FIG. 3 is a diagram of an exemplary process for conducting playback of one or more portions of interest of an item of media content.

FIG. 4 is a diagram of a second exemplary process for conducting playback of one or more portions of interest of an item of media content.

### DETAILED DESCRIPTION

### System Overview

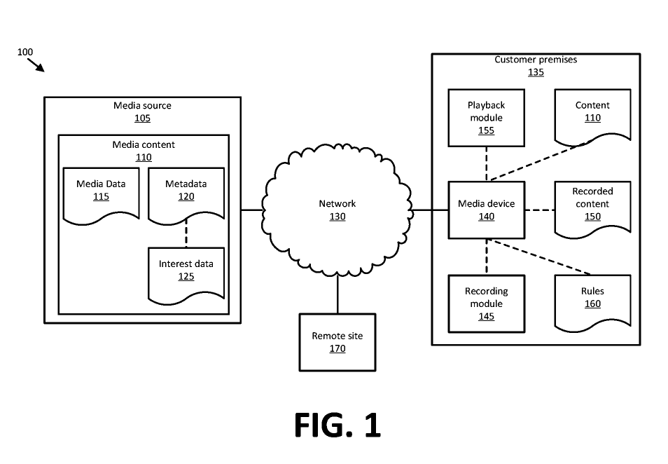

FIG. 1 is a block diagram of an exemplary media content delivery system 100. Using certain elements of the system 100 as disclosed herein, in an exemplary implementation, a digital media processing device 140 may record a video program that includes media content 110. In addition to media data 115, e.g., frames of video and associated audio, the media content 110 may include metadata 120 describing various attributes and/or portions of the media data 115. The media source 105 may also store, e.g., included in the metadata 120, interest data 125 related to an item of media content 110. The interest data 125 generally includes indicia of likely user interest, e.g., a tag or keyword or the like, or a numerical value indicating or rating a likely level of user interest in a portion of the media data 115, e.g., relating to an excitement level or the like for the portion of media data 115.

Accordingly, with reference to certain of the exemplary elements shown in FIG. 1, a media source 105 in the system 100 includes media content 110, e.g., streaming content such as a video presentation, e.g., a presentation of a sporting event or other public event, a news presentation, a movie, program, etc. The media content 110 may be provided via a network 130 to a media device 140 that is generally located in a customer premises 135.

A recording module 145 included in the media device 140 may record and store the content 110 as recorded content 150 on a computer readable medium included in or accessible by the media device 140. Further, the media device 140, e.g., via a playback module 155 included therein, may play back such a recording, e.g., upon a user request, by identifying portions of the media content 110 for which the interest data 125 indicates a predetermined interest level, e.g., an excitement level, is met or exceeded. Portions of the media content 110 so identified are then included in, and all other portions of the media content 110 may be excluded from, the playback.

### Exemplary System Elements

### Media Source

In general, media source 105 may include multiple elements for processing, storing, and providing media content 110 and related data. Elements of the media source 105 may be local to one another and/or may be distributed amongst multiple locations. For example, media source 105 may include one or more computer servers (some or all of which may be referred to as “media servers”) and data storage devices, e.g., for storing and processing content 110 and other data such as discussed herein.

In general, the media source 105 may be any one or some combination of various mechanisms for delivering media content 110, e.g., one or more computing devices and storage devices, and may depend on a type of media content 110 being provided. By way of example and not limitation, media content 110 data may be provided as video-on-demand through a cable, satellite, or internet protocol television (IPTV) distribution system, as streaming Internet video data, or as some other kind of data. Accordingly, the media source 105 may include one or more of a cable or satellite television head-end, a video streaming service that generally includes a multimedia web server (or some other computing device), or some other mechanism for delivering multimedia data. In general, examples of media content 110 include various types of data, including audio, video, images, etc.

Media content 110 is generally delivered via the network 130 in a digital format, e.g., as compressed audio and/or video data. The media content 110 generally includes, according to such digital format, media data 115 and media metadata 120. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media content 110 may be provided in a format such as the MPEG-1, MPEG-2 or the H.264/MPEG-4 Advanced Video Coding standards (AVC) (H.264 and MPEG-4 at present being consistent), or according to some other standard or standards. For example, media content 110 could be audio data formatted according to standards such as MPEG-2 Audio Layer III (MP3), Advanced Audio Coding (AAC), etc. Further, the foregoing standards generally provide for including metadata, e.g. media metadata 120, along with media data 115, in a file of media content 110, such as the media metadata 120 discussed herein (and moreover, as discussed elsewhere herein, the metadata 120 may include other elements such as interest data 125).

Media content 110 includes media content as it is usually provided for general distribution, e.g., a sports, news, or entertainment program, etc., in a form has provided by a distributor of the media content 110 via a media source 105. Alternatively or additionally, media content 110 may be modified from the form provided by a general distributor of content (e.g., recompressed, re-encoded, etc.). In any case, media data 115 generally includes data by which a display, playback, representation, etc. of the media content 110 is presented by a media device 140, e.g., on a display device such a monitor, television set, etc. For example, media data 115 generally includes units of encoded and/or compressed video data, e.g., frames of an MPEG file or stream.

Media metadata 120 may include metadata as provided by an encoding standard such as an MPEG standard. Alternatively and/or additionally, media metadata 120 could be stored and/or provided separately to a media device 140, apart from media data 115. In general, media metadata 120 provides general descriptive information for an item of media content 110. Examples of media metadata 120 include information such as content 110 title, chapter, actor information, Motion Picture Association of America MPAA rating information, reviews, and other information that describes an item of media content 110. Information for metadata 120 may be gathered from a content producer, e.g., a movie studio, media information aggregators, and other sources such as critical movie reviews.

As already mentioned, the metadata 120 may include other elements such as interest data 125. Accordingly, generally as part of metadata 120 in media content 110, interest data 125 may be provided from the media source 105 to one or more media devices 140. The interest data 125 generally includes one or more indicia of interest, e.g., a numerical excitement or interest rating, a descriptive keyword or tag, etc., relating to a portion or portions of media data 115. Interest data 125 may be provided according to a variety of mechanisms, e.g., a third party vendor may supply interest data 125 concerning an item of media content 110 in real time or near real time as the media content 110, e.g., a live sporting event, is made available from the media source 105.

In addition, to specify exciting and/or interesting portions of media data 115, interest data 125 generally further includes a pointer or pointers or the like to a location or locations in media data 115, e.g., according to timestamps or other indices. Such pointers may be used to associate one or more interest data, e.g., a numerical interest level or a tag indicated an interest, with an indexed location in media data 115. Accordingly, such pointers may be used to access one or more portions of media data 115, e.g., such as may be specified according to pointers or the like provided in the metadata 120 associated with the media data 115.

### Network

Communications to and from the media source 105, customer premises 135, and one or more remote sites 170 may occur via the network 130. In general, the network 130 represents one or more mechanisms for delivering content 110 from the media source 105 to a media device 140. Accordingly, the network 130 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks, local area networks (LAN) and/or wide area networks (WAN), including the Internet, etc.

### Customer Premises

Turning to the customer premises 135, the media device 140 is generally a device including a computer processor and associated storage, e.g., volatile memory, nonvolatile memory, etc., and capable of communicating via the network 130. Exemplary media devices 140 include a set-top box that includes or is coupled to a digital video recorder (DVR), a personal computer such as a laptop, handheld, or tablet computer, a smart phone, etc. Accordingly, it is to be understood that a media device 140 may be a mobile device rather than being located in a physical customer premises all (or even some) of the time.

The media device 140 may include a display and/or may be connected to a display device, e.g., a television, or may incorporate a display device, e.g., a display of a smartphone, tablet or personal computer. When content 110 is referred to herein as being “displayed,” it is to be understood that such display could include any possible mode of displaying media data, such as a display of visual data, audio data, etc. For example, content 110 could be displayed by showing video or image data on a screen with or without sound, by playing audio data with or without a visual display, etc.

The media device 140 generally includes a recording module 145, e.g., a set of instructions stored on a memory of the device 140, and executable by a processor thereof. The recording module 145 is generally configured to record, and store on a computer-readable medium included in, or communicatively coupled to, the device 120, one or more items of recorded content 150, i.e., recorded media content 110. For example, the device 140 and the recording module 145 included thereon may function as a digital video recorder (DVR) or the like.

The media device 140 generally further includes a playback module 155, e.g., a set of instructions stored in a memory of the device 140, and executable by a processor thereof. The playback module 155 is generally configured to retrieve an item of recorded content 150 from the computer-readable medium included in or accessible by the media device 140, and to via a television set, computing device, etc. communicatively coupled to the media device 140.

Further, the playback module 155 is generally configured to identify a portion or portions of media data 115 in recorded content 150 that meets at least one pre-determined criterion of user interest. The playback module 155 is further generally configured to make this identification according to the indicia of interest included in interest data 125, as well as possibly according to one or more rules 160.

For example, the playback module 155 could be configured to identify interest data 125 included in metadata 120 for a stream of content data 110 stored as recorded content 150, and to determine whether the interest data 125 specifies an indicia of interest that should trigger playback of a portion of media data 115 in the recorded content 150. Continuing this example, metadata 120 for each frame included in an MPEG stream of media data 115 could include an interest datum 125 providing an indicia of interest such as a numerical excitement rating, e.g., on a scale from 1 to 100. Then, when the playback module 155 encountered a frame of data 115 associated with an indicia of interest at or above a predetermined threshold, e.g., 75, the playback module 155 could play back, e.g., to a device communicatively couples to the media device 140 or on a display of the media device 140, that frame of data 115. Further, any immediately adjacent or contiguous frames of data 115 that met or surpassed the threshold could likewise be captured and included for playback with the first-identified frame of data 115 that met or surpassed the threshold. Similarly, an interest datum 125 could specify start and end points, e.g., using timestamps, indices, etc., for respective starting and ending locations in a stream of media data 115 between which an indicia of interest had a specified numeric value or associated keyword, a value over a certain threshold, etc.

Likewise, an interest datum 125 could specify a tag or keyword associated with one or more frames of media data 115, and the playback module 155 could play back, frames of media data 115 in recorded content 150, where the captured frames of media data 115 were specified by the tags, keyword, etc.

Rules 160 may provide further parameters, rules, etc. for playback of recorded content 150. Rules 160 may be predefined for all users, i.e., for all media devices 140, and moreover could be stored by a media source 105 and provided and/or updated in a memory of the media device 140 by the media source 105. Alternatively or additionally, rules 160 may be customized for particular users and/or media devices 140. For example, a generic rule 160, i.e., a rule 160 for all media devices 140, could specify that for events identified in metadata 120 as sporting events, and excitement rating above a value of 75 should trigger playback of content 150, but for all other events, e.g., news events, an excitement rating above a value of 85 is required. Further, a custom rule 160 could specify that for events identified in metadata 120 as sporting events for a user's favorite team, e.g., an excitement rating above a value of 60 is required, but for other sporting events in a specified sport, e.g., baseball, an excitement rating above a value of 90 is required. Additionally or alternatively, as discussed in more detail below, a rule 160 could be used to identify an item of media content 110 for which the recording module 145 should examine interest data 125.

As mentioned above, rules 160 could be defined by a media source 105, and moreover, rules 160 could be included in instructions comprised in the playback module 155. Additionally or alternatively, rules 160 could be specified by a user of a media device 140, e.g., using a graphical user interface (GUI) or the like provided on a display associated with the media device 140. For example, such GUI could allow a user to specify keywords, tags, etc. and/or threshold values for interest ratings, e.g., excitement ratings, to trigger playback of content 150. Accordingly, a rule 160 could specify both a keyword and a threshold for a numerical interest rating, wherein a combination of the presence of the keyword and meeting or exceeding the threshold triggers recording of a clip 150 according to instructions in the recording module 145.

### Remote Sites

A remote site 170, as discussed above, may include a social media site, an e-commerce site, a news site, a site providing reference information, etc. A media device 140 could include instructions for allowing a user to specify a remote site 170 for posting a clip 150. For example, a GUI provided by the media device 140 could allow a user to specify one or more portions of recorded content 150, e.g., determined as described below, to be posted to a user's social media account, or could allow a user to specify that portion of recorded content 150 will be automatically posted to a user's social media account when the interest indicia in interest data 125 associated with the portion of recorded content 150 matches certain keywords, tags, etc. and/or meets or exceeds a specified numeric threshold. Further, a user's account on a remote site 170 could be used to provide tags or the like indicating user interest in subjects that could then be matched to one or more interest data 125.

### Interest Detection

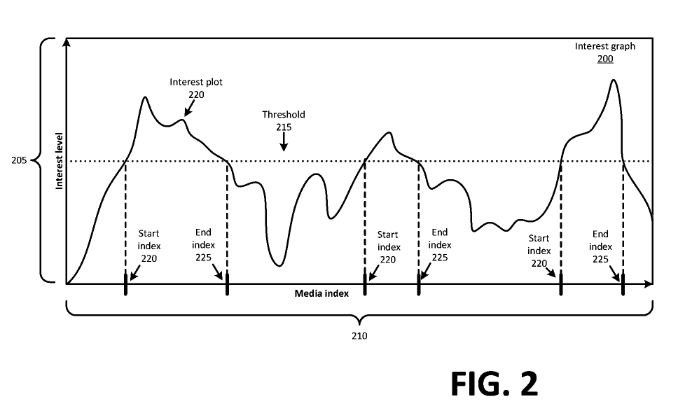

FIG. 2 is a block diagram of an interest graph 200. The graph 200 includes an interest level axis 205 and a media index axis 210. The horizontal dotted line across the graph 200 indicates an interest threshold 215. The interest plot 220 illustrates how an interest level for various indices in recorded content 150 may vary over indices included in the media content 110. At a point at which the plot 220 crosses above the threshold 215, a start index 220 may be indicated. At a point at which the plot 220 falls below the threshold 215, an end index 225 is indicated. Thus, the indices 220, 225 may be used to specify portions of recorded content 150 to be played back by the module 155. The threshold 215 may be a pre-determined textual or numerical value specified by an interest datum 125 and may be stored in the module 155 and/or retrieved from the media source 105.

Further, in the case of a numerical threshold 215, the threshold 215 could be varied according to a particular use of a media device 140, a type or attributes of media content 110 (e.g., the threshold 215 could be higher for a baseball game than for a football game, or could be lower for a items of media content 110 featuring a particular sports team than for items of media content for a particular sport in general, etc.). Moreover, the module 155 could store multiple thresholds 215 to be used in combination with one another. For example, a numerical threshold 215 could be used in combination with a textual threshold specifying a tag or the like in interest data 125. Then, when the module 125 encountered a tag in metadata 120 matching the threshold tag 215, the module 155 could further determine whether a numerical threshold 215 was met or exceeded for that tag. For example, a threshold tag 215 could specify the name of a football team, and a numerical threshold 215 could specify an excitement level 215 at which the playback module 155 should playback a portion of recorded content 150. In any case, as is evident from the foregoing description, the word “threshold” as used herein may encompass both textual descriptions, e.g., tags, as well as numerical values.

It is also possible that one or more thresholds 215 may be specified by a user. For example, the media device 140 could present a graphical user interface (GUI) or the like by which a user could specify a threshold 215, e.g., a tag, numerical interest level, etc. that the user desires to trigger playback of a portion or portions of recorded content 150. Where different numerical thresholds 215 are to be applied to different tag thresholds 215, the user could, e.g., via the GUI, specify such association, e.g., an interest level of 80 for baseball games, and an interest level of 75 for football games.

### Exemplary Process Flows

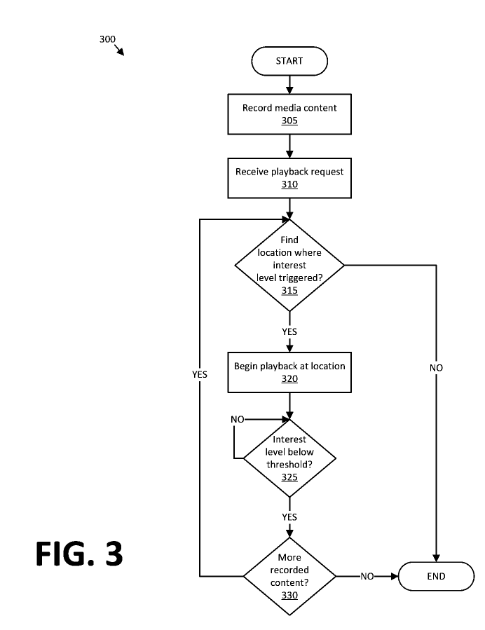

FIG. 3 is a diagram of an exemplary process 300 for conducting playback of one or more portions of interest of an item of media content.

The process 300 begins in a block 305, in which the media device 140 creates and stores a set of recorded content 150. For example, as mentioned above, the media device 140 may receive media content 110 from a media source 105 via the network 130. The media device 140 may be a DVR or the like configured to record an item or items of media content 110, or the media device 140 could be some other device, e.g., a computing device configured to record an item or items of media content 110 according to a real-time or near real-time user request, a pre-programmed user request, etc. In any event, the media device 140 generally stores the recorded content 150 and a computer readable medium included in or associated with the media device 140 in the customer premises 135. However, recorded content 150 could also be stored in a data store at the media source 105 or that is otherwise outside the customer premises 135 and accessible via the network 130.

Next, in a block 310, the device 140 receives a request to play back portions of interest in an item of recorded content 150. For example, the device 140 could present a GUI, e.g., as part of an interactive program guide (IPG) where the device 140 is a set top box, in a webpage viewable with a standard web browser or the device 140 is a general-purpose computing device, etc. Such GUI could list recorded content 150 having portions of interest available for playback. Also, as mentioned above, the GUI could allow a user, either at the time of selecting recorded content 150 for playback or previously, to specify one or more thresholds 215 to be applied to the playback.

Alternatively or additionally, a user profile or the like could be stored in the media device 140, and/or at the media source 105 and provided to the media device 140, where the user profile included data by which the module 155 could specify one or more thresholds 215 and/or by which thresholds 215 could be applied. For example, user profile information could specify a threshold 215 or combination of thresholds 215, along with a rule 160 specifying an item of media content 110, a genre (e.g., sporting events, football games, political events, etc.) of media content 110, etc., to which the specified threshold(s) 215 should be applied.

In general, a user profile, which could be generated according to user-provided input, according to information gathered by user viewing habits, etc., could identify types of programming, and attributes of types of programming, of interest to a user. These program types and/or attributes could be specified in a rule 160. For example, the media device 140 could store and/or could receive from the media source 105 data, e.g., one or more rules 160, indicating that a user of the media device 140 was very interested in the game of football and/or an identity of a particular football team. The module 155 could then generate one or more thresholds 215 according to such rule or rules 160.

Following the block 310, next, in a block 315, the device 140, e.g., according to instructions in the playback module 155, attempts to locate a portion of recorded content 150 according to one or more thresholds 215 and interest data 125. For example, the module 155 could examine interest data 125 associated with respective frames of media data 155 in an item of recorded content 150. A start index 220 could be identified where interest data 125 matched or exceeded one or more thresholds 215. For example, numerical interest data 125 could match or exceed a numerical threshold 215 and/or tag or textual interest data 125 could match a tag or text specified in a threshold 215 (e.g., strings could be identical or substantially similar, a rule 160 could specify that a given tag and interest data 125 should match a given threshold 215 or vice-versa, e.g., “basketball” might match “hoops”), etc. In any event, if a start index 220 is identified in the block 315, then a block 320 is executed next. Otherwise, the process 300 ends following the block 315.

In the block 320, the module 155 begins playback of recorded content 150 at the start index 220 identified in the block 315.

Following the block 320, in the block 325, the module 155 determines whether, as playback of the recorded content 150 proceeds, an interest level continues to match and/or remains at or above the one or more specified thresholds 215, i.e., whether an end index 225 has been located associated with the start index 220 from which playback begun. For example, the module 155 could consider interest data 125 associated with respective frames of media data 115. The module 155 could also determine that an interest level has fallen below threshold(s) 215 or that an end index 225 has been reached if an end of recorded content 150 is reached. In any event, if the determination of the block 325 is negative, then the process 300 remains in the block 325. Otherwise, the process 300 proceeds to the block 330.

In the block 330, the module 155 determines whether more recorded content 150 remains for possible playback. As illustrated in FIG. 2, multiple index 220, 225 pairs could be identified in an item of recorded content 150, and selected for playback by the module 155. If no further recorded content 150 remains for possible playback, i.e., an end of recorded content 150 has been reached, then the process 300 ends. Otherwise, the process 300 returns to the block 315 to attempt to locate an additional portion of recorded content 150 meeting or exceeding the specified interest threshold(s) 215.

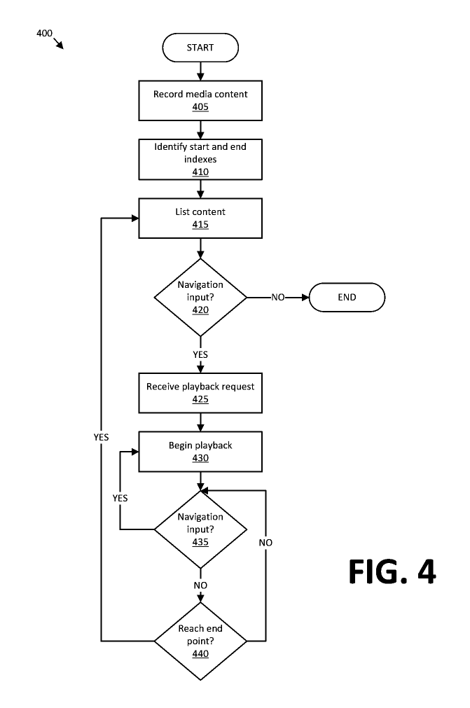

FIG. 4 is a diagram of a second exemplary process for conducting playback of one or more portions of interest of an item of media content.

The process 400 begins in a block 405, which may be executed in a manner substantially similar to that described above with respect to the block 305.

Next, in a block 410, the module 155 analyzes an item of recorded content 150 to attempt to identify one or more pairs of indexes 220, 225. Further, it is to be understood that multiple items of content 110 could be stored as recorded content 150, and so analyzed, prior to execution of the block 415, which may follow the block 410.

In any event, for an item of recorded content 150, with reference to FIG. 2, the device 140 could analyze interest data 125 included in the recorded content 150 to locate a first start index 220, i.e., a beginning point in the recording 150 at which an interest level met or exceeded at least one threshold 215. The device 140 would likewise analyze the interest data 125 to determine a first end index 225 associated with the first start index 220, thereby identifying a portion of the data 150 for which one or more interest thresholds 215 have been met or exceeded. Further, the device 140, e.g., the module 155, could analyze remaining interest data 125 associated with respective frames of media data 115 in the recorded data 150 to identify second, third, etc. pairs of indexes 220, 225.

In a block 415, the device 140, e.g., via a GUI or the like, lists items of recorded content 150 available for playback according to identified portions of interest. The block 415 may follow the block 410, although it is also possible that the blocks 405 and 410 could be separately and/or previously executed, and the process 400 could begin with the block 415.

In any case, the GUI could display a list of one or more portions of the content 150 for which one or more interest thresholds 215 were met or exceeded, e.g., by time index, according to a tag included in interest data 125 or other metadata 120, including the interest thresholds 215 that were met or exceeded, etc. A user could select a portion of the content 150 for playback by selecting a link or the like, and further the GUI could provide mechanisms, e.g., navigation buttons such as arrows or the like, to allow users to navigate from a first portion of recorded content 150 to a second, e.g., a next, portion of the recorded content 150 where such portions were associated with interest levels meeting or exceeding one or more thresholds 215. Likewise, a remote control device such as is known, e.g. including programmable softkeys or the like, could be used for such user selection and navigation of portions of recorded content 150. Moreover, such navigation input could be provided in response to a listing of recorded content 150 or portions thereof in a GUI, as would be the case with respect to block 420 described below, and/or could be received while a portion of recorded content 150 is being played back, e.g., as described with respect to the block 435 below.

Accordingly, in a block 420 following the block 415, the module 155 determines whether a navigation input has been received in the device 140, e.g., according to a user selection from a GUI as described above. If no such input is received, e.g., within a predetermined time, or input is received to exit the GUI displayed by the device 140, etc., then the process 400 ends. However, if navigation input is received in the block 420, then a block 425 is executed next.

In the block 425, the device 140 receives a playback request for a portion of an item of recorded content 150 according to the navigation input provided as described above with respect to the block 420.

Next, in the block 430, the device 140 begins playback of the requested portion of recorded content 150.

Following the block 430, in a block 435, the module 155 determines whether navigation input has been received. For example, a menu or list of other portions of one or more items of recorded content 150 could be overlaid on, drop-down on, etc., an interface in which a current portion of recorded content 150 is being played. Additionally or alternatively, navigation arrows representing previous and next portions of recorded content 150 and/or buttons with numbers or descriptions representing portions of recorded content 150 could be displayed along with or overlaid on a display of a current portion of recorded content 150 being played. In any event, if navigation input is received according to the foregoing or some other input mechanism, then the process 400 returns to the block 430 to begin playback of the newly requested portion of an item of recorded content 150. Otherwise, the process 400 proceeds to a block 440.

In the block 440, the module 155 determines whether an end index 225 of the portion of recorded content 150 being played has been reached. If not, the process 400 returns to the block 435. If so, the process 400 returns to the block 415.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A computing device that includes a processor and a memory, the device configured to:
record a stream of media content;
determine that a numerical value in metadata of the recorded media content associated with an index in the media content matches or exceeds a predetermined value;
receive a request to play back the recorded media content; and
play back the recorded media content beginning at the index specified by the metadata.

2. The device of claim 1, further configured to display a graphical user interface including a link to the recorded content.

3. The device of claim 1, further configured to end playback of the media at a second index at which the numerical value in the metadata falls below a predetermined value.

4. The device of claim 3, further configured to:
determine that a numerical value in metadata of the recorded media content associated with a third index in the media content matches or exceeds a predetermined value; and
play back the recorded media content beginning at the third index specified by the metadata.

5. The device of claim 1, wherein the device comprises a digital video recorder (DVR).

6. A computing device that includes a processor and a memory, the device configured to:
record a stream of media content;
determine a first start index in the recorded media content according to a first location in the media content at which a metadata value matches or exceeds a predetermined value;
play the media content beginning at the first start index;
determine a first end index at a second location in the recorded media content following the first start index at which the metadata value fails to match or exceed the predetermined value; and
cease play of the media content at the first end index.

7. The device of claim 6, wherein the metadata value is one of a numerical rating and a textual description.

8. The device of claim 6, wherein the predetermined value is one of numerical threshold and a textual description.

9. The device of claim 6, further configured to display a graphical user interface including a link to the recorded content.

10. The device of claim 6, further configured to play the media content beginning at the start index in response to user input to play the recorded content.

11. The device of claim 6, further configured to:
determine a second start index in the recorded media content according to a third location in the media content at which a metadata value matches or exceeds a predetermined value;
play the media content beginning at the second start index;
determine a second end index at a fourth location in the recorded media content following the second start index at which the metadata value fails to match or exceed the predetermined value; and
cease play of the media content at the second end index.

12. The device of claim 6, wherein the device comprises a digital video recorder (DVR).

13. A computing device that includes a processor and a memory, the device configured to:
record a stream of media content;
determine a start index in the recorded media content according to a first location in the media content at which a metadata value matches or exceeds a predetermined value;
determine an end index at a second location in the recorded media content following the start index at which the metadata value fails to match or exceed the predetermined value; and
play a portion of the recorded content determined by the start index and the end index.

14. The device of claim 13, wherein the metadata value is one of a numerical rating and a textual description.

15. The device of claim 13, wherein the predetermined value is one of numerical threshold and a textual description.

16. The device of claim 13, further configured to display a graphical user interface including a link to the recorded content.

17. The device of claim 13, further configured to play the media content beginning at the start index in response to user input to play the portion of recorded content specified by the start index and the end index.

18. The device of claim 13, further configured to:
determine a second start index in the recorded media content according to a third location in the media content at which a metadata value matches or exceeds a predetermined value;
determine a second end index at a fourth location in the recorded media content following the second start index at which the metadata value fails to match or exceed the predetermined value; and
play a portion of the recorded content determined by the second start index and the second end index.

19. The device of claim 13, wherein the device comprises a digital video recorder (DVR).
